(19) United States
(12) Patent Application Publication
(10) Pub. No.: US 2026/0320752 A1
(43) Pub. Date: Oct. 15, 2026

(54) IMAGE PROCESSING

(71) Applicant: BAIDU.COM TIMES TECHNOLOGY (BEIJING) CO., LTD., BEIJING (CN)

(72) Inventors: Chang LIU, BEIJING (CN); Li ZHANG, BEIJING (CN); Zaishen YANG, BEIJING (CN); Ying WANG, BEIJING (CN)

(73) Assignee: BAIDU.COM TIMES TECHNOLOGY (BEIJING) CO., LTD., BEIJING (CN)

(21) Appl. No.: 19/705,586

(22) Filed: Jun. 11, 2026

(30) Foreign Application Priority Data
Nov. 5, 2025 (CN) 202511613086.X

(51) Int. Cl. G06T 5/50; G06T 5/30; G06T 5/70; G06T 7/194

(52) U.S. Cl. CPC G06T 5/50; G06T 5/30; G06T 5/70; G06T 7/194; G06T 2207/20221

(57) ABSTRACT

An image processing method and apparatus, a device, and a medium are provided. The method includes: identifying a subject corresponding to a target region in an original image in response to detecting an input target operation on the original image; performing a dilation operation on the subject to obtain a neighboring region of the subject; inputting a region identification map and the original image into a matting model to obtain a foreground mask, where the region identification map identifies respective positions of the subject and the neighboring region in the original image; separating the original image into a foreground image and a background image based on the foreground mask; performing a blur operation on the background image to obtain a blurred background image; merging the blurred background image and the foreground image into a preview image; and outputting the preview image.

### CROSS REFERENCE TO RELATED APPLICATION (MPEP 201.13, 37 CFR 1.57(B), MPEP § 608.01(P))

This application claims priority to Chinese Patent Application No. 202511613086.X, filed on Nov. 5, 2025, the contents of which are hereby incorporated by reference in their entirety for all purposes.

### TECHNICAL FIELD

The present disclosure relates to the technical field of artificial intelligence, in particular to the technical fields such as computer vision and deep learning, and specifically relates to an image processing method, an image processing apparatus, an electronic device, a computer-readable storage medium, and a computer program product.

### BACKGROUND

Artificial intelligence is a subject on making a computer simulate some thinking processes and intelligent behaviors (such as learning, reasoning, thinking, and planning) of a human, and involves both hardware-level technologies and software-level technologies. Artificial intelligence hardware technologies generally include the technologies such as sensors, dedicated artificial intelligence chips, cloud computing, distributed storage, and big data processing. Artificial intelligence software technologies mainly include the following several general directions: natural language processing technologies, computer vision technologies, speech recognition technologies and machine learning/deep learning, big data processing technologies, and knowledge graph technologies.

The approaches described in this section are not necessarily those that have been previously conceived or pursued. Unless otherwise indicated, it should not be assumed that any of the approaches described in this section qualify as prior art merely by virtue of their inclusion in this section. Similarly, issues mentioned in this section should not be assumed to have been recognized in any prior art, unless otherwise indicated.

### SUMMARY

The present disclosure provides an image processing method, an image processing apparatus, an electronic device, a computer-readable storage medium, and a computer program product.

According to an aspect of the present disclosure, an image processing method is provided. The image processing method includes: identifying a subject corresponding to a target region in an original image in response to detecting an input target operation on the original image; performing a dilation operation on the subject to obtain a neighboring region of the subject; inputting a region identification map and the original image into a matting model to obtain a foreground mask, where the region identification map identifies respective positions of the subject and the neighboring region in the original image; separating the original image into a foreground image and a background image based on the foreground mask; performing a blur operation on the background image to obtain a blurred background image; merging the blurred background image and the foreground image into a preview image; and outputting the preview image.

According to another aspect of the present disclosure, an image processing apparatus is provided. The image processing apparatus includes: an identification unit configured to identify a subject corresponding to a target region in an original image in response to detecting an input target operation on the original image; a dilation unit configured to perform a dilation operation on the subject to obtain a neighboring region of the subject; a matting unit configured to input a region identification map and the original image into a matting model to obtain a foreground mask, where the region identification map identifies respective positions of the subject and the neighboring region in the original image; an image separation unit configured to separate the original image into a foreground image and a background image based on the foreground mask; a blurring unit configured to perform a blur operation on the background image to obtain a blurred background image; a preview unit configured to merge the blurred background image and the foreground image into a preview image; and an output unit configured to output the preview image.

According to another aspect of the present disclosure, an electronic device is provided. The electronic device includes: one or more processors; a memory storing one or more programs configured to be executed by the one or more processors, the one or more programs including instructions for: identifying a subject corresponding to a target region in an original image in response to detecting an input target operation on the original image; performing a dilation operation on the subject to obtain a neighboring region of the subject; inputting a region identification map and the original image into a matting model to obtain a foreground mask, where the region identification map identifies respective positions of the subject and the neighboring region in the original image; separating the original image into a foreground image and a background image based on the foreground mask; performing a blur operation on the background image to obtain a blurred background image; merging the blurred background image and the foreground image into a preview image; and outputting the preview image.

According to another aspect of the present disclosure, a non-transient computer-readable storage medium storing one or more programs, the one or more programs including instructions, which when executed by one or more processors of an electronic device, cause the electronic device to: identify a subject corresponding to a target region in an original image in response to detecting an input target operation on the original image; perform a dilation operation on the subject to obtain a neighboring region of the subject; input a region identification map and the original image into a matting model to obtain a foreground mask, where the region identification map identifies respective positions of the subject and the neighboring region in the original image; separate the original image into a foreground image and a background image based on the foreground mask; perform a blur operation on the background image to obtain a blurred background image; merge the blurred background image and the foreground image into a preview image; and output the preview image.

According to another aspect of the present disclosure, a computer program product including a computer program is provided, where the computer program, when executed by a processor, causes the method described above to be implemented.

According to one or more embodiments of the present disclosure, in the present disclosure, after an input target operation on an original image is detected, a subject corresponding to a target region is first identified, and a neighboring region of the subject, i.e., an edge region that a matting model needs to focus on, is obtained through a dilation operation. Then, the original image together with the region identification map identifying the respective positions of the subject and the neighboring region in the original image are input into the matting model, so that the matting model can generate a matting result with better edge processing, i.e., the foreground mask. Afterwards, by separating the foreground from the background, and blurring the background and then merging the blurred background and the clear foreground image into the preview image, it is possible to quickly and accurately eliminate interference caused by the complex background to a user, so that the user can intuitively determine edge quality of the matting result, thereby improving overall efficiency and accuracy of a matting operation and reducing complexity of user operations.

It should be understood that the descriptions in this section are not intended to identify critical or essential features of the embodiments of the present disclosure, nor are they intended to limit the scope of the present disclosure. Other features of the present disclosure will be readily understood from the following description.

### BRIEF DESCRIPTIONS OF THE DRAWINGS

The accompanying drawings illustratively depict example embodiments and form a part of the specification, serving to illustrate example implementations of the embodiments together with the written description of the specification. The embodiments shown are intended for illustrative purposes only and do not limit the scope of the claims. Throughout the accompanying drawings, the same reference numerals denote similar, but not necessarily identical, elements.

FIG. 1 is a schematic diagram of an example system in which various methods described herein can be implemented according to an embodiment of the present disclosure;

FIG. 2 is a flowchart of an image processing method according to an embodiment of the present disclosure;

FIG. 3 is a flowchart of performing a dilation operation on a subject to obtain a neighboring region of the subject according to an embodiment of the present disclosure;

FIG. 4 is a flowchart of performing a blur operation on a background image to obtain a blurred background image according to an embodiment of the present disclosure;

FIG. 5 is a flowchart of an image processing method according to an embodiment of the present disclosure;

FIG. 6A to FIG. 6C are schematic diagrams of an image processing method according to an embodiment of the present disclosure;

FIG. 7 is a structural block diagram of an image processing apparatus according to an embodiment of the present disclosure; and

FIG. 8 is a structural block diagram of an example electronic device that can be used to implement an embodiment of the present disclosure.

### DETAILED DESCRIPTION OF THE EMBODIMENTS

The following description of example embodiments of the present disclosure is made with reference to the accompanying drawings, which includes various details of the embodiments of the present disclosure to aid understanding and should be considered as merely illustrative. Therefore, those of ordinary skill in the art should be aware that various changes and modifications can be made to the embodiments described herein, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one element from another. In some examples, a first element and a second element may refer to a same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of the listed terms.

In the related art, existing image matting methods often suffer from problems of poor matting effect and poor human-computer interaction experience. In particular, when processing an image with complex edges, the existing matting methods often yield low-quality matting results, making it difficult for users to quickly determine edge quality of the matting results against a complex background.

To solve the aforementioned problem, in the present disclosure, after an input target operation on an original image is detected, a subject corresponding to a target region is first identified, and a neighboring region of the subject, i.e., an edge region that a matting model needs to focus on, is obtained through a dilation operation. Then, the original image together with a region identification map identifying respective positions of the subject and the neighboring region in the original image are input into the matting model, so that the matting model can generate a matting result with better edge processing, i.e., a foreground mask. Afterwards, by separating the foreground from the background, and blurring the background and then merging the blurred background and the clear foreground image into a preview image, it is possible to quickly and accurately eliminate interference caused by the complex background to a user, so that the user can intuitively determine edge quality of the matting result, thereby improving overall efficiency and accuracy of a matting operation and reducing complexity of user operations.

The embodiments of the present disclosure will be described below in detail with reference to the accompanying drawings.

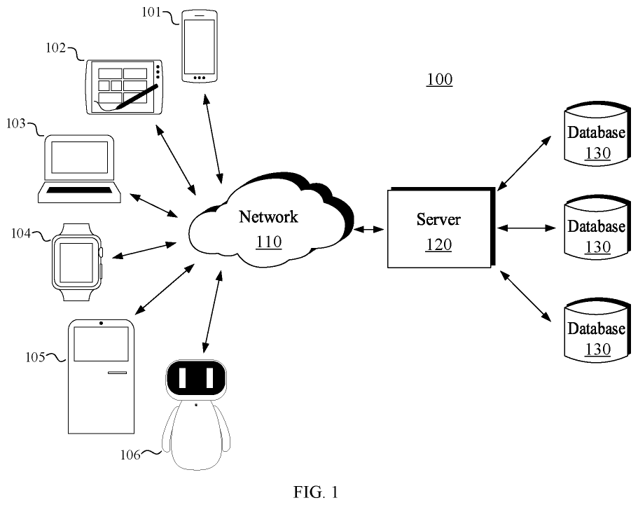

FIG. 1 is a schematic diagram of an example system 100 in which various methods and apparatuses described herein can be implemented according to an embodiment of the present disclosure. Referring to FIG. 1, the system 100 includes one or more client devices 101, 102, 103, 104, 105, and 106, a server 120, and one or more communication networks 110 that couple the one or more client devices to the server 120. The client devices 101, 102, 103, 104, 105, and 106 may be configured to execute one or more applications.

In an embodiment of the present disclosure, the server 120 can run one or more services or software applications that enable a method according to the present disclosure to be performed.

In some embodiments, the server 120 may further provide other services or software applications that may include a non-virtual environment and a virtual environment. In some embodiments, these services may be provided as web-based services or cloud services, for example, provided to a user of the client devices 101, 102, 103, 104, 105, and/or 106 in a software-as-a-service (SaaS) model.

In the configuration shown in FIG. 1, the server 120 may include one or more components that implement functions performed by the server 120. These components may include software components, hardware components, or a combination thereof that can be executed by one or more processors. The user operating the client devices 101, 102, 103, 104, 105, and/or 106 may sequentially use one or more client applications to interact with the server 120, to use the services provided by these components. It should be understood that various different system configurations are possible, and may be different from that of the system 100. Therefore, FIG. 1 is an example of the system for implementing various methods described herein, and is not intended to be limiting.

The user may use the client devices 101, 102, 103, 104, 105, and/or 106 to perform human-computer interaction. The client device may provide an interface that enables the user of the client device to interact with the client device. The client device may further output information to the user via the interface. Although FIG. 1 shows only six client devices, those skilled in the art will understand that any number of client devices can be supported in the present disclosure.

The client devices 101, 102, 103, 104, 105, and/or 106 may include various types of computer devices, such as a portable handheld device, a general-purpose computer (such as a personal computer and a laptop computer), a workstation computer, a wearable device, a smart screen device, a self-service terminal device, a service robot, a gaming system, a thin client, various messaging devices, and a sensor or other sensing devices. These computer devices can run various types and versions of software applications and operating systems, such as MICROSOFT Windows, APPLE iOS, a UNIX-like operating system, and a Linux or Linux-like operating system (e.g., GOOGLE Chrome OS), or include various mobile operating systems, such as MICROSOFT Windows Mobile OS, iOS, Windows Phone, and Android. The portable handheld device may include a cellular phone, a smartphone, a tablet computer, a personal digital assistant (PDA), etc. The wearable device may include a head-mounted display (such as smart glasses) and other devices. The gaming system may include various handheld gaming devices, Internet-enabled gaming devices, etc. The client device can execute various applications, such as various Internet-related applications, communication applications (e.g., email applications), and short message service (SMS) applications, and can use various communication protocols.

The network 110 may be any type of network well known to those skilled in the art, and may use any one of a plurality of available protocols (including but not limited to TCP/IP, SNA, IPX, etc.) to support data communication. As a mere example, the one or more networks 110 may be a local area network (LAN), an Ethernet-based network, a token ring, a wide area network (WAN), the Internet, a virtual network, a virtual private network (VPN), an intranet, an extranet, a blockchain network, a public switched telephone network (PSTN), an infrared network, a wireless network (e.g., Bluetooth or WIFI), and/or any combination of these and/or other networks.

The server 120 may include one or more general-purpose computers, a dedicated server computer (e.g., a personal computer (PC) server, a UNIX server, or a terminal server), a blade server, a mainframe computer, a server cluster, or any other suitable arrangement and/or combination. The server 120 may include one or more virtual machines running a virtual operating system, or other computing architectures related to virtualization (e.g., one or more flexible pools of logical storage devices that can be virtualized to maintain virtual storage devices of a server). In various embodiments, the server 120 can run one or more services or software applications that provide functions described below.

A computing unit in the server 120 can run one or more operating systems including any one of the above-mentioned operating systems and any commercially available server operating system. The server 120 can also run any one of various additional server applications and/or middle-tier applications, including an HTTP server, an FTP server, a CGI server, a JAVA server, a database server, etc.

In some implementations, the server 120 may include one or more applications to analyze and merge data feeds and/or event updates received from users of the client devices 101, 102, 103, 104, 105, and/or 106. The server 120 may further include one or more applications to display the data feeds and/or real-time events via one or more display devices of the client devices 101, 102, 103, 104, 105, and/or 106.

In some implementations, the server 120 may be a server in a distributed system, or a server combined with a blockchain. The server 120 may alternatively be a cloud server, or an intelligent cloud computing server or intelligent cloud host with artificial intelligence technologies. The cloud server is a host product in a cloud computing service system, to overcome the shortcomings of difficult management and weak service scalability in conventional physical host and virtual private server (VPS) services.

The system 100 may further include one or more databases 130. In some embodiments, these databases can be used to store data and other information. For example, one or more of the databases 130 can be configured to store information such as an audio file and a video file. The databases 130 may reside in various positions. For example, a database used by the server 120 may be locally in the server 120, or may be remote from the server 120 and may communicate with the server 120 via a network-based or dedicated connection. The database 130 may be of different types. In some embodiments, the database used by the server 120 may be, for example, a relational database. One or more of these databases can store, update, and retrieve data from or to the database, in response to a command.

In some embodiments, one or more of the databases 130 may further be used by an application to store application data. The database used by the application may be of different types, for example, may be a key-value repository, an object repository, or a regular repository backed by a file system.

The system 100 of FIG. 1 may be configured and operated in various manners, so that the various methods and apparatuses described according to the present disclosure can be applied.

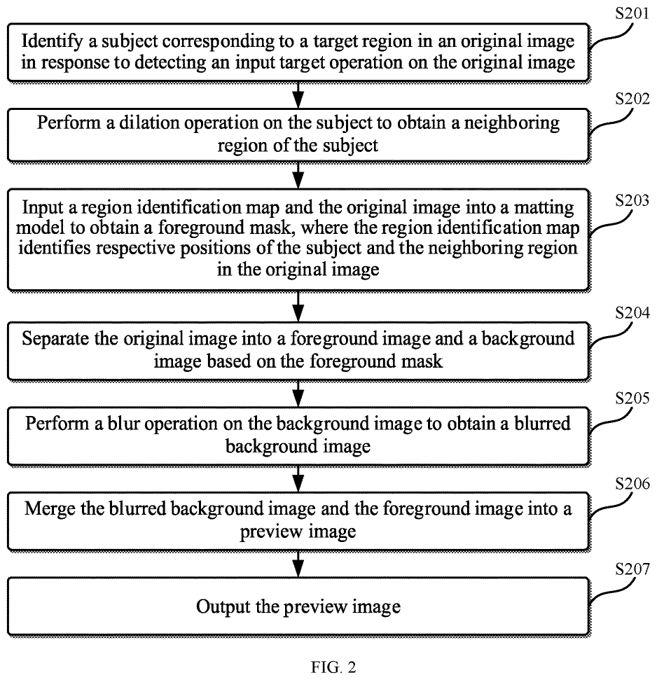

According to an aspect of the present disclosure, an image processing method is provided. As shown in FIG. 2, the method includes: step S201 of identifying a subject corresponding to a target region in an original image in response to detecting an input target operation on the original image; step S202 of performing a dilation operation on the subject to obtain a neighboring region of the subject; step S203 of inputting a region identification map and the original image into a matting model to obtain a foreground mask, where the region identification map identifies respective positions of the subject and the neighboring region in the original image; step S204 of separating the original image into a foreground image and a background image based on the foreground mask; step S205 of performing a blur operation on the background image to obtain a blurred background image; step S206 of merging the blurred background image and the foreground image into a preview image; and step S207 of outputting the preview image.

Thus, in the present disclosure, after the input target operation on the original image is detected, the subject corresponding to the target region is first identified, and the neighboring region of the subject, i.e., an edge region that the matting model needs to focus on, is obtained through a dilation operation. Then, the original image together with the region identification map identifying the respective positions of the subject and the neighboring region in the original image are input into the matting model, so that the matting model can generate a matting result with better edge processing, i.e., the foreground mask. Afterwards, by separating the foreground from the background, and blurring the background and then merging the blurred background and the clear foreground image into the preview image, it is possible to quickly and accurately eliminate interference caused by the complex background to a user, so that the user can intuitively determine edge quality of the matting result, thereby improving overall efficiency and accuracy of a matting operation and reducing complexity of user operations.

In some embodiments, the image processing method may be applied to an image processing system or software having a matting function. In step S201, the system may call a deep learning model (for example, an image semantic segmentation model) to process the original image, so as to extract the subject corresponding to the target region, or the subject may be identified in the original image through other means. It should be noted that the subject is not a matting result, but image subject content preliminarily identified.

In some embodiments, the system may provide two matting modes: a smart selection mode driven jointly by a user and an image recognition method, and a manual mode driven entirely by the user. In the smart selection mode, the target operation detected in step S201 may be a painting operation performed by the user on the original image, and the target region may be a painted region. With the painting operation, the user can express their matting intent and indicate a rough position and a general range of an object to be separated from the background. It can be understood that the target operation may alternatively be other operations for setting a specific region (i.e., the target region) in the original image, which is not limited herein.

After the subject is obtained, the foreground mask used as a matting result is obtained through the dilation operation in step S202 and a matting operation in step S203.

The neighboring region of the subject is a region surrounding the subject, a region close to the subject, and/or a region located on or near the edge of the subject. This region is a main focus region for matting.

In some embodiments, in step S202, the subject may be dilated using a fixed dilation intensity. A region corresponding to the subject may be subtracted from a region obtained after the dilation to obtain the neighboring region of the subject; or a region obtained after eroding the subject may be subtracted from a region obtained after the dilation to obtain the neighboring region of the subject, or the neighboring region may be obtained through other means.

The region identification map has the same size as the original image, with a value of each pixel indicating that the pixel belongs to the subject, the neighboring region, or another region. The region identification map can indicate the positions of the subject and the neighboring region in the original image.

In some embodiments, in step S203, the region identification map together with the original image may be input into the matting model (for example, a deep learning model such as ModNet) to obtain the foreground mask. The foreground mask may be, for example, an alpha mask.

After the foreground mask is obtained, in step S204, the original image is separated into the foreground image and the background image based on the foreground mask.

In some embodiments, the foreground mask may be a grayscale image having the same size as the original image, with a value (for example, between 0 and 255) of each pixel representing a transparency of a pixel at a corresponding position of the original image belonging to the foreground. A color value of each pixel of the original image may be multiplied by a transparency value (for example, a normalized value between 0 and 1) at a corresponding position of the foreground mask, to obtain the foreground image. Similarly, the color value of each pixel of the original image may be multiplied by (1 minus the transparency value), to obtain the background image.

In some embodiments, in step S205, the blur operation is performed on the background image to obtain the blurred background image, while the clear foreground image is retained.

In some embodiments, the blur operation may include but is not limited to Gaussian blur, mean blur, median blur, mosaic processing, or pixelation. By performing the blur operation on the background image, it is possible to effectively reduce interference caused by high-frequency details such as complex textures, highlights, or noises that may exist in the background image to the line of sight of the user, providing a low-interference background for the subsequent preview image.

In some embodiments, in step S206, the blurred background image and the foreground image are merged into the preview image. The preview image may be displayed on an interactive interface on which the user performs the painting operation. Compared with the method in the related art of directly displaying the foreground on a transparent “checkerboard” background, the preview image of the present disclosure can effectively eliminate visual interference from the background, so that the user can intuitively determine edge quality of the foreground mask generated by the matting model, thereby improving overall efficiency and accuracy of the matting operation and reducing complexity of user operations.

In some embodiments, in step S207, the preview image may be output for displaying to the user.

According to some embodiments, as shown in FIG. 3, step S202 of performing the dilation operation on the subject to obtain the neighboring region of the subject may include: step S301 of performing edge analysis on the subject to obtain a plurality of edge segments of the subject; step S302 of determining respective dilation intensities of the plurality of edge segments; and step S303 of performing the dilation operation on the plurality of edge segments based on the respective dilation intensities of the plurality of edge segments, to obtain the neighboring region.

Thus, by applying different dilation intensities to different edge segments of the subject, in the present disclosure, a dynamic asymmetric neighboring region can be generated for a subsequent matting model, enabling the model to concentrate more computing resources on complex edges that are difficult to process, thereby improving matting accuracy and efficiency.

In some embodiments, in step S301, the edge analysis may include: first extracting an outer boundary contour of the subject; and then traversing along the contour, and dividing the contour into a plurality of continuous edge segments based on a preset contour division rule. The preset contour division rule may include a fixed pixel length, an angle change, a semantic boundary, or other rules.

In some embodiments, in step S302, the system may determine the respective dilation intensities of the plurality of edge segments based on respective features of the plurality of edge segments. For example, a larger dilation intensity may be set for an edge segment with a higher edge complexity. The dilation intensity may be a numerical value, and may be a pixel value of a morphological dilation operation radius.

In some embodiments, in step S303, the system may independently perform, for each edge segment, the dilation operation using the dilation intensity determined for the edge segment in step S302. Finally, the dilation results of all the edge segments may be merged (for example, through a logical “OR” operation) to form a complete neighboring region.

According to some embodiments, step S302 of determining the respective dilation intensities of the plurality of edge segments may include: calculating respective contour curvatures of the plurality of edge segments, where the respective dilation intensities of the plurality of edge segments are positively correlated with corresponding contour curvatures of the edge segments.

Thus, by associating the dilation intensity with the contour curvature, the complexity of the edge can be quantified using a geometric feature of the edge, so as to allocate a larger neighboring region to fine edges with a high curvature such as hair strands and wrinkles, guiding the matting model to perform focused processing.

In some embodiments, a plurality of sampling points may be selected from each edge segment, and a local curvature or a curvature change rate at these sampling points may be calculated. An average curvature or a maximum curvature of an edge segment may be used as a contour curvature of the segment. The positive correlation may be implemented as a linear or nonlinear mapping function that maps a calculated curvature value into a preset dilation intensity range (for example, 5 pixels to 50 pixels).

According to some embodiments, the edge analysis includes extracting semantic labels of the plurality of edge segments, and the respective dilation intensities of the plurality of edge segments are determined based on preset dilation intensities of corresponding semantic labels of the edge segments.

Thus, by using high-level semantic prior knowledge, edge regions that are essentially difficult to process can be identified more accurately, thereby achieving a more intelligent and robust dilation intensity allocation.

In some embodiments, the semantic labels may be generated by a lightweight image segmentation or classification model in the edge analysis step. The system may pre-configure a mapping table or a rule library, in which different dilation intensities are respectively preset for different semantic labels (for example, hair, fur, skin, clothing outlines, etc.). For example, a preset dilation intensity corresponding to a “hair” label may be much larger than a preset dilation intensity corresponding to a “skin” label.

According to some embodiments, step S302 of determining the respective dilation intensities of the plurality of edge segments may include: calculating respective texture complexities of the plurality of edge segments, where the respective dilation intensities of the plurality of edge segments are positively correlated with corresponding texture complexities of the edge segments.

Thus, by analyzing the texture complexity of the edge neighboring region, complex edges caused by materials can be effectively processed, thereby further improving the accuracy of the edge analysis.

In some embodiments, the calculation of the texture complexity may include: for each edge segment, analyzing a pixel value change of an original image region neighboring to the edge segment. In an example embodiment, a gradient magnitude, a gray-level co-occurrence matrix feature, or a local binary pattern of the region may be calculated. A larger dilation intensity may be set for a region with a higher texture complexity.

According to some embodiments, the neighboring region includes a plurality of neighboring sub-regions obtained by separately performing the dilation operation on the plurality of edge segments, and in the region identification map, the plurality of neighboring sub-regions have respective identification values, and the respective identification values of the plurality of neighboring sub-regions increase or decrease with corresponding dilation intensities of the edge segments.

Thus, since the dilation intensity characterizes an edge complexity degree of each edge segment, by encoding the identification value associated with the dilation intensity into the region identification map, the matting model can be guided to perform different processing on edges of different complexity degrees, thereby improving the obtained foreground mask with better quality.

In some embodiments, the identification value may be a set of preset discrete integer values or a continuous floating-point value range. In an example embodiment, the system may map the calculated dilation intensity (for example, a radius value of 5 pixels to 50 pixels) to a pixel value (for example, a grayscale value of 50 to 250) of the “neighboring region” in the region identification map through a linear or nonlinear function. In this way, the pixel value of the neighboring region in the region identification map can carry complexity information of its corresponding edge segment.

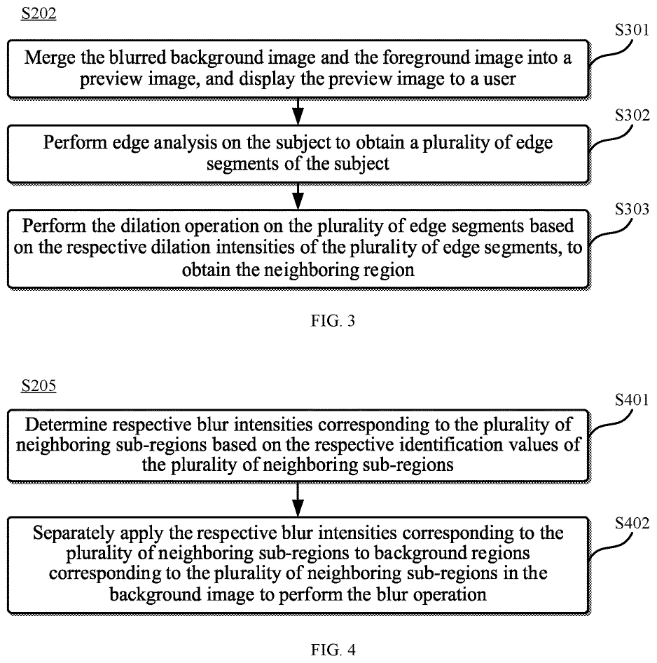

According to some embodiments, as shown in FIG. 4, step S205 of performing the blur operation on the background image to obtain the blurred background image may include: step S401 of determining respective blur intensities corresponding to the plurality of neighboring sub-regions based on the respective identification values of the plurality of neighboring sub-regions; and step S402 of separately applying the respective blur intensities corresponding to the plurality of neighboring sub-regions to background regions corresponding to the plurality of neighboring sub-regions in the background image to perform the blur operation.

Thus, different blur intensities can be applied to different regions of the background image based on the identification values determined in the upstream step, realizing differential processing of the background, so that the user can better focus on the complex edge regions.

In some embodiments, in step S401, the system may pre-build a lookup table or a function to map the identification value (for example, a grayscale value of 50 to 250) to a blur intensity. The blur intensity may include but is not limited to a radius of Gaussian blur, a kernel size of mean blur, or a blur parameter such as a downsampling factor of a subsequent downsampling operation.

In some embodiments, in step S402, the background regions corresponding to the plurality of neighboring sub-regions may be background pixel regions in the background image that are spatially neighboring to neighboring sub-regions.

In an example embodiment, the above “neighboring” may be quantified as a fixed distance. For example, the corresponding background region may include: in the background image, all background pixels within a range of a preset distance threshold from a boundary of each neighboring sub-region.

In other embodiments, the range of the above “neighboring” may be dynamically determined. For example, the range may be associated with a feature of the neighboring sub-region (its dilation intensity or identification value). In an example embodiment, for each neighboring sub-region, using its corresponding dilation intensity or identification value as a parameter (for example, as a radius of a dilation kernel), a morphological dilation operation is performed on the neighboring sub-region within the range of the background image, and a background pixel region covered by this morphological dilation operation may be determined as the corresponding background region.

According to some embodiments, the blur intensity may include a downsampling factor. Step S402 of separately applying the respective blur intensities corresponding to the plurality of neighboring sub-regions to the background regions corresponding to the plurality of neighboring sub-regions in the background image to perform the blur operation may include: for each neighboring sub-region, downsampling a background region corresponding to the neighboring sub-region based on a downsampling factor of the neighboring sub-region, to obtain an intermediate result; and upsampling the intermediate result to obtain a blur result of the background region.

Thus, by implementing the blur operation by performing downsampling and then upsampling, computational overheads can be reduced while ensuring a blur effect, improving a processing speed.

In some embodiments, the downsampling factor may be positively correlated with the blur intensity. A higher blur intensity may correspond to a larger downsampling factor. In step S402, the system may apply, for each adjacent background region, its corresponding downsampling factor to perform image scaling, to obtain the intermediate result; and then the system may upsample the intermediate result back to an original size, thereby forming a pixelated blur effect in the region.

According to some embodiments, the respective blur intensities corresponding to the plurality of neighboring sub-regions are positively correlated with the identification values of the corresponding neighboring sub-regions.

Thus, a higher blur intensity can be applied to a background region corresponding to a high identification value, thereby visually highlighting its neighboring foreground edge, making it easier for the user to determine the quality of a matting edge.

In an example embodiment, a high-complexity edge (for example, a high contour curvature) corresponds to a high dilation intensity, and further corresponds to a high identification value. This embodiment further defines that the blur intensity is positively correlated with the identification value. In this way, a highest level of blur is applied to a background region neighboring to the high-complexity edge, thereby eliminating visual interference to the greatest extent, making it easier for the user to accurately determine the high-complexity edge.

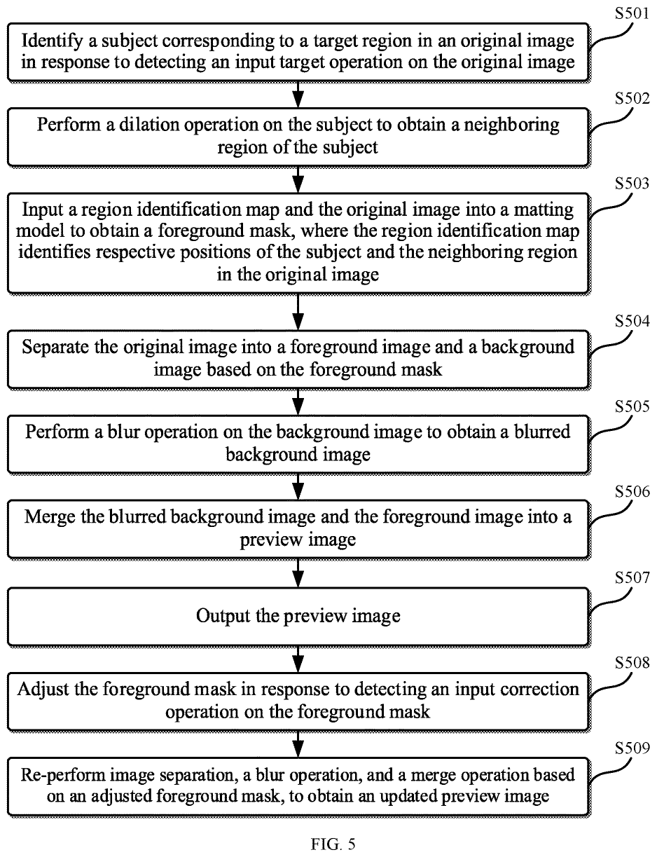

According to some embodiments, as shown in FIG. 5, the image processing method may further include: step S508 of adjusting the foreground mask in response to detecting an input correction operation on the foreground mask; and step S509 of re-performing image separation, a blur operation, and a merge operation based on an adjusted foreground mask, to obtain an updated preview image.

It can be understood that for operations of step S501 to step S507 in FIG. 5, reference may be made to the above description of step S201 to step S207 in FIG. 2. Details are not described herein again.

After the preview image is output in step S507, the user can intuitively determine matting quality based on the preview image, and correct the matting through step S508 and step S509. Thus, these steps provide the user with a closed-loop workflow from automatic matting processing to manual fine correction, realizing real-time feedback and iterative optimization of a matting result.

In some embodiments, after the preview image is output in step S507, a correction tool for manually correcting the foreground mask may be automatically displayed in a matting interface. The correction tool may include a “paint” tool (for increasing a foreground region) and an “erase” tool (for reducing the foreground region). Correspondingly, the correction operation may include an operation of increasing the foreground region and an operation of reducing the foreground region. In step S508, an operation of the user using the correction tool is used to update the foreground mask in real time. In step S509, each time the foreground mask is adjusted, the system may automatically repeat the operations of step S504 to step S507 in real time, i.e., re-separating the image, blurring the background, merging, and outputting an instantly updated preview image.

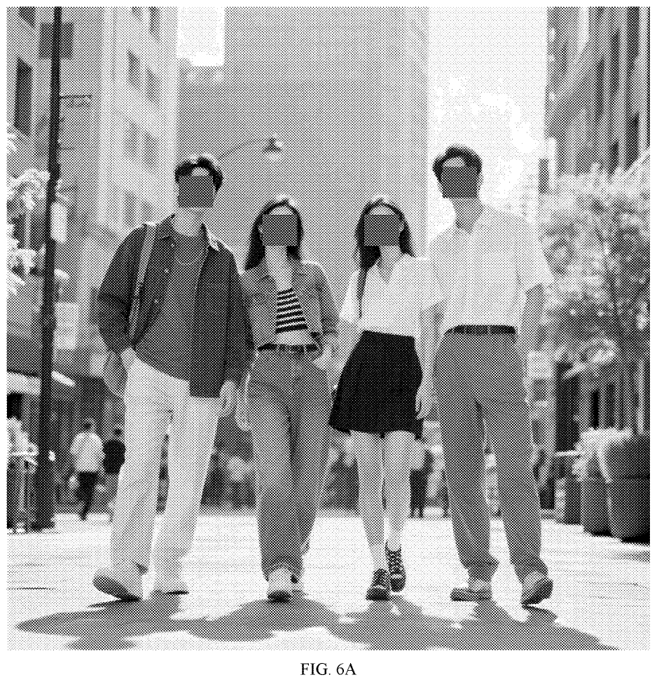

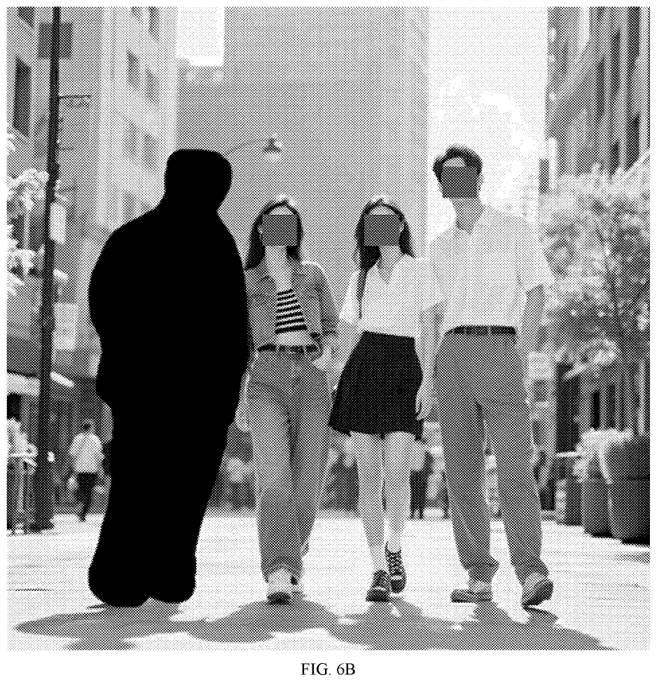

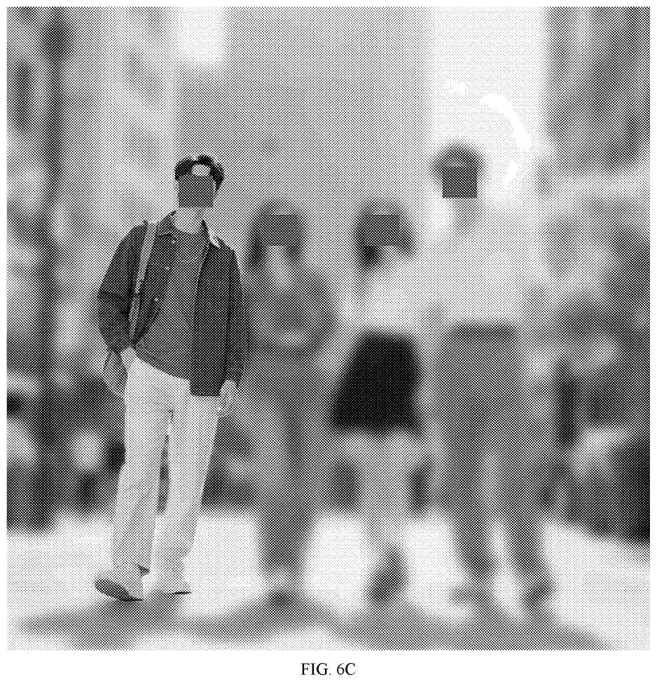

FIG. 6A to FIG. 6C are schematic diagrams of an image processing method according to an example embodiment of the present disclosure. As shown in FIG. 6A, an original image to be processed may include a plurality of persons and a complex background. As shown in FIG. 6B, the user may perform a rough painting operation (as shown by a black stroke in the figure) on the original image, to indicate a subject of interest, i.e., a leftmost person. As shown in FIG. 6C, in the image processing method of the present disclosure, in response to the painting operation, automatic identification is performed and matting is completed, a complete and clear foreground image (i.e., the leftmost person) is extracted, a blur operation is performed on the background image, and the clear foreground image and the blurred background image are merged into a preview image and then the preview image is output.

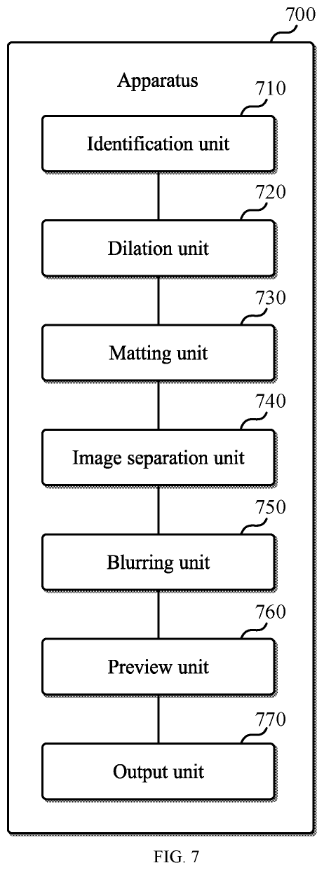

According to another aspect of the present disclosure, an image processing apparatus is provided. As shown in FIG. 7, the apparatus 700 includes: an identification unit 710 configured to identify a subject corresponding to a target region in an original image in response to detecting an input target operation on the original image; a dilation unit 720 configured to perform a dilation operation on the subject to obtain a neighboring region of the subject; a matting unit 730 configured to input a region identification map and the original image into a matting model to obtain a foreground mask, where the region identification map identifies respective positions of the subject and the neighboring region in the original image; an image separation unit 740 configured to separate the original image into a foreground image and a background image based on the foreground mask; a blurring unit 750 configured to perform a blur operation on the background image to obtain a blurred background image; a preview unit 760 configured to merge the blurred background image and the foreground image into a preview image; and an output unit 770 configured to output the preview image.

It can be understood that for operations and effects of the units 710 to 770 in the apparatus 700, reference may be made to the above description of step S201 to step S207. Details are not described herein again.

In the technical solutions of the present disclosure, collection, storage, use, processing, transmission, provision, disclosure, etc. of user personal information involved all comply with related laws and regulations and are not against the public order and good morals.

According to embodiments of the present disclosure, an electronic device, a readable storage medium, and a computer program product are further provided.

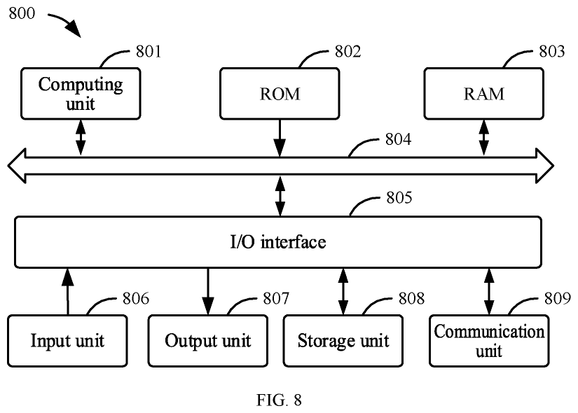

Referring to FIG. 8, a structural block diagram of an electronic device 800 will be described below, which can serve as a server or a client of the present disclosure and is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown in the present specification, their connections and relationships, and their functions are merely examples, and are not intended to limit the implementation of the present disclosure described and/or required herein.

As shown in FIG. 8, the electronic device 800 includes a computing unit 801, and the computing unit may perform various appropriate actions and processing according to a computer program stored in a read-only memory (ROM) 802 or a computer program loaded from a storage unit 808 to a random access memory (RAM) 803. The RAM 803 may further store various programs and data required for the operation of the electronic device 800. The computing unit 801, the ROM 802, and the RAM 803 are connected to each other through a bus 804. An input/output (I/O) interface 805 is also connected to the bus 804.

A plurality of components in the electronic device 800 are connected to the I/O interface 805, including: an input unit 806, an output unit 807, the storage unit 808, and a communication unit 809. The input unit 806 may be any type of device capable of inputting information to the electronic device 800, the input unit 806 may receive input digit or character information and generate a key signal input related to user settings and/or function control of the electronic device, and may include, but is not limited to, a mouse, a keyboard, a touchscreen, a trackpad, a trackball, a joystick, a microphone, and/or a remote controller. The output unit 807 may be any type of device capable of presenting information, and may include, but is not limited to, a display, a speaker, a video/audio output terminal, a vibrator, and/or a printer. The storage unit 808 may include, but is not limited to, a magnetic disk and an optical disk. The communication unit 809 allows the electronic device 800 to exchange information/data with other devices via a computer network such as the Internet and/or various telecommunication networks, and may include, but is not limited to, a modem, a network interface card, an infrared communication device, a wireless communication transceiver, and/or a chipset, for example, a Bluetooth device, an 802.11 device, a Wi-Fi device, a WiMax device, and/or a cellular communication device.

The computing unit 801 may be various general-purpose and/or special-purpose processing components with processing and computing capabilities. Some examples of the computing unit 801 include, but are not limited to, a central processing unit (CPU), a graphics processing unit (GPU), various dedicated artificial intelligence (AI) computing chips, various computing units on which machine learning model algorithms run, a digital signal processor (DSP), and any appropriate processor, controller, microcontroller, etc. The computing unit 801 performs the various methods, processes, and/or processing described above. For example, in some embodiments, these methods, processes, and/or processing may be implemented as a computer software program tangibly embodied in a machine-readable medium, such as the storage unit 808. In some embodiments, a part or all of the computer program may be loaded and/or installed onto the electronic device 800 via the ROM 802 and/or the communication unit 809. When the computer program is loaded to the RAM 803 and executed by the computing unit 801, one or more steps of the methods, processes, and/or processing described above may be performed. Alternatively, in other embodiments, the computing unit 801 may be configured, by any other appropriate means (for example, by means of firmware), to perform these methods, processes, and/or processing.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logic device (CPLD), computer hardware, firmware, software, and/or a combination thereof. These various implementations may include implementation in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output means, and transmit data and instructions to the storage system, the at least one input apparatus, and the at least one output means.

Program codes used to implement the method of the present disclosure can be written in any combination of one or more programming languages. The program code may be provided for a processor or a controller of a general-purpose computer, a special-purpose computer, or other programmable data processing apparatuses, such that when the program code is executed by the processor or the controller, the functions/operations specified in the flowcharts and/or block diagrams are implemented. The program code may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing means (for example, a mouse or a trackball) through which the user can provide an input to the computer. Other categories of apparatuses can also be used to provide interaction with the user; for example, feedback provided to the user can be any form of sensory feedback (for example, visual feedback, auditory feedback, or tactile feedback); and an input from the user can be received in any form (including an acoustic input, a voice input, or a tactile input).

The systems and technologies described herein can be implemented in a computing system including a backend component (for example, as a data server), in a computing system including a middleware component (for example, an application server), in a computing system including a frontend component (for example, a user computer with a graphical user interface or a web browser through which the user can interact with the implementation of the systems and technologies described herein), or in a computing system including any combination of the backend component, the middleware component, and the frontend component. The components of the system can be connected to each other through digital data communication (for example, a communication network) in any form or medium. Examples of the communication network include: a local area network (LAN), a wide area network (WAN), the Internet, and a blockchain network.

A computer system may include a client and a server. The client and the server are generally far away from each other and usually interact through a communication network. A relationship between the client and the server is generated by computer programs running on respective computers and having a client-server relationship with each other. The server may be a cloud server, which is also referred to as a cloud computing server or a cloud host, and is a host product in a cloud computing service system for overcoming defects of difficult management and weak business expansion in conventional physical hosts and virtual private server (VPS) services. The server may alternatively be a server in a distributed system, or a server combined with a blockchain.

It should be understood that steps may be reordered, added, or deleted based on the various forms of procedures shown above. For example, the steps recorded in the present disclosure may be performed in parallel, successively, or in a different order, provided that the desired result of the technical solutions disclosed in the present disclosure can be achieved, which is not limited herein.

Although the embodiments or examples of the present disclosure have been described with reference to the accompanying drawings, it should be appreciated that the method, system, and device described above are merely example embodiments or examples, and the scope of the present disclosure is not limited by these embodiments or examples, but defined only by the granted claims and the equivalent scope thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. An image processing method, comprising:
in response to detecting an input target operation on an original image, identifying a subject corresponding to a target region in the original image;
performing a dilation operation on the subject to obtain a neighboring region of the subject;
inputting a region identification map and the original image into a matting model to obtain a foreground mask, wherein the region identification map identifies respective positions of the subject and the neighboring region in the original image;
separating the original image into a foreground image and a background image based on the foreground mask;
performing a blur operation on the background image to obtain a blurred background image;
merging the blurred background image and the foreground image into a preview image; and
outputting the preview image.

2. The method according to claim 1, wherein the performing the dilation operation comprises:
performing edge analysis on the subject to obtain a plurality of edge segments of the subject;
determining a respective dilation intensity for each edge segment of the plurality of edge segments; and
performing the dilation operation on the plurality of edge segments based on the respective dilation intensity for each edge segment of the plurality of edge segments, to obtain the neighboring region.

3. The method according to claim 2, wherein the determining the respective dilation intensity for each edge segment of the plurality of edge segments comprises:
calculating a respective contour curvature for each edge segment of the plurality of edge segments, wherein the respective dilation intensity for each edge segment of the plurality of edge segments is positively correlated with the respective contour curvature of the edge segment.

4. The method according to claim 2, wherein the edge analysis comprises extracting a semantic label for each edge segment of the plurality of edge segments, and the respective dilation intensity for each edge segment of the plurality of edge segments is determined based on a predetermined dilation intensity of the semantic label of the edge segment.

5. The method according to claim 2, wherein the determining the respective dilation intensity for each edge segment of the plurality of edge segments comprises:
calculating a respective texture complexity for each edge segment of the plurality of edge segments, wherein the respective dilation intensity for each edge segment of the plurality of edge segments is positively correlated with the respective texture complexity of the edge segment.

6. The method according to claim 2, wherein the neighboring region comprises a plurality of neighboring sub-regions obtained by separately performing the dilation operation on the plurality of edge segments, and in the region identification map, each neighboring sub-region of the plurality of neighboring sub-regions has a respective identification value, and the respective identification value increases or decreases with the respective dilation intensity of a corresponding edge segment.

7. The method according to claim 6, wherein the performing the blur operation on the background image comprises:
determining a respective blur intensity for each neighboring sub-region of the plurality of neighboring sub-regions based on the respective identification value of the neighboring sub-region; and
for each neighboring sub-region of the plurality of neighboring sub-regions, applying the respective blur intensity for the neighboring sub-region to a background region corresponding to the neighboring sub-region in the background image to perform the blur operation.

8. The method according to claim 7, wherein the respective blur intensity for each neighboring sub-region comprises a respective downsampling factor of the neighboring sub-region, and the applying the respective blur intensity for the neighboring sub-region to the background region comprises:
downsampling the background region based on the respective downsampling factor of the neighboring sub-region, to obtain an intermediate result; and
upsampling the intermediate result to obtain a blur result of the background region.

9. The method according to claim 7, wherein the respective blur intensity for each neighboring sub-region of the plurality of neighboring sub-regions is positively correlated with the respective identification value of the neighboring sub-region.

10. The method according to claim 1, further comprising:
adjusting the foreground mask in response to detecting an input correction operation on the foreground mask; and
separating the original image, performing a blur operation on the background image, and merging the blurred background image and the foreground image based on the adjusted foreground mask, to obtain an updated preview image.

11. An electronic device, comprising:
one or more processors;
a memory storing one or more programs configured to be executed by the one or more processors, the one or more programs including instructions for:
in response to detecting an input target operation on an original image, identifying a subject corresponding to a target region in the original image;
performing a dilation operation on the subject to obtain a neighboring region of the subject;
inputting a region identification map and the original image into a matting model to obtain a foreground mask, wherein the region identification map identifies respective positions of the subject and the neighboring region in the original image;
separating the original image into a foreground image and a background image based on the foreground mask;
performing a blur operation on the background image to obtain a blurred background image;
merging the blurred background image and the foreground image into a preview image; and
outputting the preview image.

12. A non-transient computer-readable storage medium storing one or more programs, the one or more programs comprising instructions, which when executed by one or more processors of an electronic device, cause the electronic device to:
in response to detecting an input target operation on an original image, identify a subject corresponding to a target region in the original image;
perform a dilation operation on the subject to obtain a neighboring region of the subject;
input a region identification map and the original image into a matting model to obtain a foreground mask, wherein the region identification map identifies respective positions of the subject and the neighboring region in the original image;
separate the original image into a foreground image and a background image based on the foreground mask;
perform a blur operation on the background image to obtain a blurred background image;
merge the blurred background image and the foreground image into a preview image; and
output the preview image.
